(19) United States
(12) Patent Application Publication
(10) Pub. No.: US 2026/0002914 A1
(43) Pub. Date: Jan. 1, 2026

(54) FLUID VALVE FOR AN ANALYSIS DEVICE

(71) Applicant: Agilent Technologies, Inc., Santa Clara, CA (US)

(72) Inventors: Achill Blatt, Waldbronn (DE); Ruben Seltmann, Waldbronn (DE); Daniel Schultz, Karlsruhe (DE); Thomas Ortmann, Straubenhardt/Ottenhausen (DE)

(21) Appl. No.: 19/251,470

(22) Filed: Jun. 26, 2025

(30) Foreign Application Priority Data
Jun. 28, 2024 (DE) 102024118383.7

(51) Int. Cl. G01N 30/20; G01N 30/32

(52) U.S. Cl. CPC G01N 30/20; G01N 30/32; G01N 2030/202; G01N 2030/328

(57) ABSTRACT

A valve, such as for an analysis device for analyzing a fluidic sample, includes a stator element having a stator boundary surface and a rotor element having a rotor boundary surface. The stator element and the rotor element are arranged in an axial direction. The stator boundary surface and the rotor boundary surface are pressed against each other in the axial direction by an axial force. The axial force is fixed by a non-detachable connection.

### CROSS-REFERENCE TO RELATED APPLICATIONS

The present application claims the benefit of German Patent Application No. DE 10 2024 118 383.7, filed on Jun. 28, 2024, which is incorporated herein by reference in its entirety.

### TECHNICAL FIELD

The present disclosure concerns a valve for an analysis device for analyzing a fluidic sample. The valve includes a stator element and a rotor element pressed against each other in an axial direction by an axial force that is fixed by a non-detachable connection, e.g. a press-fit, in at least one direction of action. The present disclosure further concerns an analysis device comprising the valve, and a method for manufacturing such a valve.

### BACKGROUND

Analysis devices such as sample separation devices are provided for the analysis of a sample, in particular a fluidic sample, e.g., for carrying out a chromatographic separation of the sample.

In an HPLC (high-performance liquid chromatography) analysis device, for example, a liquid (mobile phase) is moved at a very precisely controlled flow rate (for example, in the range of microliters to milliliters per minute) and at a high pressure (typically 20 to 1000 bar and beyond, currently up to 2000 bar), at which the compressibility of the liquid becomes noticeable, through a so-called stationary phase (for example, in a chromatographic column), in order to separate individual fractions of a sample liquid introduced into the mobile phase from one another. After passing through the stationary phase, the separated fractions of the fluidic sample are detected in a detector. Such an HPLC system is known, for example, from EP 0,309,596 B1 of the same applicant, Agilent Technologies, Inc., the entire contents of which are incorporated by reference herein.

Fluid valves for analysis devices, in particular HPLC, are e.g. check valves, rocker valves, or rotary valves, wherein the latter have a stator and a rotor. The stator is usually a stationary part, e.g. having a cylindrical shape, and having a first side with capillary connections (interface side) and a second, opposite (planar) side with cylindrical channel openings or grooves (port side) (stator boundary surface). In this case, the first side faces a fluid source (e.g., solvent supply) and is connected thereto, while the second side is coupled via the rotor to the analytical domain (e.g., sample separation column) of the analysis device. The rotor is usually provided as a rotating disk between the stator and the analytical domain of the analysis device. The rotor is pressed (with a planar surface) (rotor boundary surface) against the (planar) port side with the channel openings of the stator. By rotating the rotor with respect to the stator, individual channels can now be opened and closed, based on the respective geometry.

The boundary surfaces of the rotor and stator must be pressed against each other in the axial direction (e.g., two planar surfaces against each other) in order to achieve the necessary seal for fluids. The pressing force should be adjusted to a certain value in order to enable a sufficient seal, wherein the force must also not be too strong, because otherwise a fluid flow could be disturbed or components could be damaged.

In conventional solutions, the axial pressing force is realized with a spring force that is adjusted with an adjusting screw or by inserting spacers. However, a disadvantage of the adjusting screw is that the force may be subsequently changed by screwing, so that the desired force can no longer be restorable. A further problem of a known solution is that the adjusting screw is centered over the thread, which generally comprises a large tolerance. However, this also means that the bushing, which serves as a bearing for the shaft, is poorly centered on the valve axis. This can lead to problems with regard to the service life and the function of the valve in general. Furthermore, the mentioned spacers may lead to an iterative production process, which is very time-consuming and thus also disadvantageous.

### SUMMARY

There may be a need to provide an efficient, robust and reliable valve for an analysis device.

According to a first exemplary embodiment of the present disclosure, a (fluid) valve (e.g., a rotary valve), in particular for an analysis device (e.g., HPLC) for analyzing a fluidic sample, is described. The valve comprises:
i) a stator element having a stator boundary surface (port side, opposite the interface side) and ii) a rotor element having a rotor boundary surface (port side, opposite the interface to the analytical system).

The stator element and the rotor element are arranged in an axial direction (of the valve, in the main extension direction), wherein the stator boundary surface and the rotor boundary surface are pressed against each other in the axial direction by an axial force (in particular a pressing force that acts in/along the axial direction). In particular, the axial force (in at least one direction of action, in particular in both (opposite) directions of action) is fixed by a non-detachable connection.

According to a second exemplary embodiment of the present disclosure, an analysis device is described that comprises at least one valve as described above.

According to a third exemplary embodiment of the present disclosure, a method is described for manufacturing a valve (e.g., as described above) comprising a stator element and a rotor element that are pressed against each other in an axial direction with an axial force, the method comprising: i) adjusting the axial force and ii) fixing the axial force by a non-detachable connection (in at least one direction of action).

In the context of the present document, the term “non-detachable connection” may denote in particular a connection that is not detachable in a non-destructive manner. An illustrative example of a non-detachable connection may be a press-fit (or a cylinder press-fit composite). In this case, an element is pressed into an opening (e.g., a pressing element or a stator element in a valve body) in such a manner that the element may no longer be removed without destroying at least a part of the opening or of the element. In principle, although pressing out may be carried out, this is not considered to be detachable in a non-destructive manner in the present context. A further example of a non-detachable connection may be a material connection. For example, an element may be adhesively bonded, soldered or welded in an opening of the valve body. In one example, the non-detachable connection is free of detachable connection elements such as screws.

In the context of the present document, the term “axial force fixed” may refer in particular to the fact that a force that acts along (parallel) to the valve axis (in particular defined by the rotor shaft) is set and maintained at a specific pressure. The non-detachable connection may be used in order to fix the axial force (for pressing together the rotor and stator) at a specific/desired value. This may take place, for example, by a spring being pretensioned up to a specific value and then being non-detachably fixed in this position.

In the context of the present document, the term “fixed in at least one (action) direction” may refer to the fact that the axial force is non-detachably fixed in at least one direction, while it is at least temporarily detachable in the other, opposite direction. The axial force acts along the valve axis and therefore has two directions. Illustratively, the axial force may be realized via a spring force, wherein the spring may be expanded in two (opposite) directions. According to the present disclosure, the expansion in at least one of these directions may be blocked by the non-detachable connection (e.g., a pressed-in sleeve). In one exemplary embodiment of the present disclosure, the axial force may be fixed in the opposite direction (with respect to the non-detachable connection) by a detachable connection, for example the stator element. In another exemplary embodiment of the present disclosure, however, the axial force may also be fixed in both opposite directions by non-detachable connections, e.g., if the stator element functions as a press-in element.

In the context of the present document, the term “stator element” may denote in particular a stator, or a part thereof, of an analysis device. A stator element may be a component that, in particular during operation, is not moved, i.e. is arranged in a static manner. A stator element may be configured in a cylindrical or similar manner and comprise two opposite sides. While the first side may be connected to one or more fluid supplies, the second, opposite side may be coupled to the rotor element and may be configured in a planar manner for this purpose. The stator element may thus be used for providing one or more fluids, while the rotor element may switch between different operating modes.

In the context of the present document, the term “rotor element” may denote in particular a rotor, or a part thereof, of an analysis device. A rotor element may be a component that, in particular during operation, is moved, i.e. is arranged in a rotatable manner (with respect to the stator element). The rotor element may also be configured in a cylindrical or similar manner (in particular in a disc-shaped manner), wherein the side that contacts the stator element may be configured in a planar manner. The rotor element may be switched (similar to a switch position) by rotating between different fluid paths, wherein the fluids are provided by the stator element and in particular (after the mixing/proportioning) are also discharged again through the stator element.

In the context of the present document, the term “fluid” denotes in particular a liquid and/or a gas, optionally comprising solid particles.

In the context of the present document, the term “fluidic sample” denotes in particular a medium, further in particular a liquid, which contains the matter actually to be analyzed (for example, a biological sample), such as for example a protein solution, a pharmaceutical sample, etc.

In the context of the present document, the term “mobile phase” denotes in particular a fluid, further in particular a liquid, which serves as a carrier medium for transporting the fluidic sample between a fluid drive and a sample separation unit. However, the mobile phase may also be used in a fluid conveying device for influencing the fluidic sample. For example, the mobile phase may be a (for example, organic and/or inorganic) solvent or a solvent composition (for example, water and ethanol).

In the context of the present document, the term “analysis device” may denote in particular a device which is able and configured to examine, in particular to separate, a fluidic sample, further in particular to separate it into different fractions. For example, such a sample separation may take place by chromatography or electrophoresis. The analysis device may be a liquid chromatography sample separation device.

According to one exemplary embodiment, the present disclosure may be based on the idea that an efficient, robust and reliable valve for an analysis device may be provided if the axial force (for pressing together the rotor element and the stator element) is fixed in at least one direction by a non-detachable connection (or is not detachable in a non-destructive manner). Such a non-detachable connection may be realized, e.g., in a simple manner by a press-fit, in that a pressing sleeve is pressed into the valve body.

Conventionally, such an axial force (pressing force) is fixed by a detachable connection, e.g. an adjusting screw. According to the present disclosure, however, a completely different way is now selected: the axial force is fixed in a non-detachable manner (in at least one direction). This method may ensure that always the same exact axial force (e.g., spring force) is present, even over a long period of time. An accidental or unintentional adjustment of the axial force as in the case of an adjusting screw is advantageously impossible. Furthermore, the, in particular automated, manufacturability may be improved with regard to complexity and speed. This is in particular because an adjusting screw no longer has to be rotated, but only a pressing force (e.g., by a mounting press) is used. In other words: measuring and pressing may be carried out efficiently and quickly, in particular in an automated manner. A further advantage may be seen in the fact that a press-in element (e.g., a press-in sleeve) may be precisely centered for providing the non-detachable connection. Correspondingly, rotor shaft and/or rotor seal may be guided more efficiently.

The axial force required for sealing the valve (e.g., implemented as spring pretension) may be achieved, for example, by force-path-controlled pressing-in of a pressing element or of the stator element. Corresponding valves according to the present disclosure no longer have to be (substantially) serviced since they may be designed for the service life of the device (e.g., analysis device).

In one exemplary embodiment, the force adjusted during production cannot be subsequently changed by the user/customer. Moreover, in one example, the valve can no longer be opened for service, which is also not desirable since the valve can only be built under production conditions with a suitable tool in order to ensure its service life. In a further example (in which the stator is not pressed in), service can furthermore be possible, but only not with regard to the adjusted pressing force. The described solution requires fewer parts, is simpler to produce and thus more cost-effective. It also advantageously ensures that the force adjustment is not changed later.

### EXEMPLARY EMBODIMENTS

According to an exemplary embodiment, the non-detachable connection comprises at least one of the following features: a form-fit connection (in particular a press-fit connection), a material connection (in particular an adhesive connection), a soldered connection, a welded connection. In an exemplary embodiment, a non-detachable connection is provided by a press-fit. In this case, an element (e.g., a pressing element such as a sleeve, or also the stator element itself) may be pressed into the valve body in such a manner that a non-destructive removal is impossible. Such pressing-in may be implemented by a pressing force (by a pressing device such as a press). In one example, the pressed-in element may have a diameter that is at least partially larger than the opening into which the element is pressed.

In an illustrative example, the axial force may be realized via a spring that is pretensioned up to a specific point and this pretension is then fixed. If the fixing is carried out via a press-fit, this may be referred to as a non-detachable connection.

According to an exemplary embodiment, the non-detachable connection is free of detachable connection elements, in particular screws. In contrast to conventional means such as adjusting screws, a non-detachable fixing of the axial force is provided in a targeted manner according to the present disclosure.

According to an exemplary embodiment, the axial force comprises a spring force. This may enable a simple and reliable realization by proven components such as (plate) springs. According to an exemplary embodiment, the axial force is fixed to a predetermined (desired) value. This may have the advantage that the desired value of the axial force is fixed and is no longer changed or can be changed. A long service life with reliable operation may thus be ensured.

According to an exemplary embodiment, the valve is configured as a rotary valve, in particular as a rotary shear valve. According to an exemplary embodiment, the valve is configured as a high-pressure valve. According to an exemplary embodiment, the valve is configured as a fluid valve, in particular as a fluid switching valve. According to an exemplary embodiment, the axial force closes the valve in a fluid-tight manner. These features may have the advantage that the disclosure may be implemented directly in economically/technically important applications.

According to an exemplary embodiment, the valve comprises: a rotor shaft that is coupled to the rotor element. In particular, the rotor shaft is coupled/connected to a wider (disk-shaped, flange-shaped) rotor device. In an example, the rotor device (or the rotor shaft) comprises a drive element (e.g., drive pins) in order to bring the rotor element into rotation. The rotor shaft may be driven by a drive device (e.g., an electric motor). According to an exemplary embodiment, the rotor shaft is configured to enable a rotation of the rotor element. According to an exemplary embodiment, the rotor shaft is arranged along the axial direction (or defines the axial direction). In this way, an efficient rotation may be achieved, even under a high contact pressure on the stator element.

According to an exemplary embodiment, the valve comprises at least one elastic element. According to an exemplary embodiment, the elastic element is arranged in the axial direction. According to an exemplary embodiment, the elastic element is configured to provide at least a part of the axial force. This may have the advantage that an adjustable (and fixable) axial force may be implemented directly and simply with proven technical means.

According to an exemplary embodiment, the elastic element is configured as a spring, in particular a plate spring. According to an exemplary embodiment, the elastic element is configured to be cylindrical. According to an exemplary embodiment, the elastic element is arranged, in particular cylindrically, around the rotor shaft. According to an exemplary embodiment, the elastic element is configured as a radial bearing. One or more of these features may enable an efficient and reliable realization of the elastic element. A configuration as a spring, which is arranged cylindrically around the rotor shaft, may, for example, be especially space-saving and at the same time protected and stable.

According to an exemplary embodiment, the valve comprises a pressing element, in particular a pressing sleeve. According to an exemplary embodiment, the pressing element is fixed in the axial direction by the non-detachable connection, in particular the press-fit connection.

According to an exemplary embodiment, the pressing element is configured to be cylindrical. According to an exemplary embodiment, the pressing element is arranged, in particular cylindrically, around the rotor shaft. According to an exemplary embodiment, the elastic element is arranged between the pressing element and the rotor element. These configurations may have the advantage that the pressing element may be arranged in a space-saving and/or centered manner and ensures an efficient movement of rotor shaft.

According to an exemplary embodiment, the valve comprises: a blocking element that is arranged in the axial direction and is configured to block an expansion of the elastic element in one direction. The blocking element may be used in particular in an exemplary embodiment in which the stator element is pressed into the valve body. In this case, the elastic element is displaced by the stator-side pressing force. However, the blocking element may block this yielding in a simple manner, so that the elastic element is pretensionized.

According to an exemplary embodiment, the blocking element is configured as part of the valve body (or of the housing). This may be a simple and robust implementation. According to an exemplary embodiment, the blocking element is arranged, in particular cylindrically, around the rotor shaft. As a result, space may be saved, while the movement of the rotor shaft remains undisturbed. According to an exemplary embodiment, the elastic element is arranged between the blocking element and the rotor element (or the rotor device).

According to an exemplary embodiment, the valve comprises: an axial bearing, in particular arranged between the pressing element (or the blocking element) and the elastic element. According to an exemplary embodiment, the valve comprises: a radial bearing, in particular arranged between the elastic element and the rotor element. In an example, the radial bearing is configured as a ball bearing or plain bearing. This may have the advantage that an efficient force distribution and mode of operation is enabled with proven and established techniques.

According to an exemplary embodiment, the valve comprises: a valve body in which the rotor element and at least a part of the stator element are arranged. In the present context, the term “valve body” may denote in particular at least a part of the valve in which the rotor element (and the rotor shaft), the elastic element and (at least partially) the stator element are arranged. The valve body may thus be considered to be a housing in which these parts are arranged. The blocking element may be configured as part of this housing in an example. In an example, the valve body comprises at least partially a cylinder shape. In an example, the valve body comprises a front (stator side) opening and/or an opposite (rotor side) opening, wherein the latter may be coupled to a drive device. Pressing-in of the stator element is carried out from the stator side in an example. Pressing-in of the pressing element is carried out from the rotor side in an example.

According to an exemplary embodiment, the stator element is fastened to the valve body, in particular by a detachable connection, further in particular by a screw connection. Independently of the non-detachably fixed axial force, the stator element may be removable or exchangeable in an example. For this embodiment, the stator element may be detachably fastened to the valve body/housing, e.g. by magnets, rotating-in, screwing-in or by a fastening element. This may have the advantage that the stator element may be flexibly handled and serviced. Furthermore, the stator element may also be arranged on the valve only after adjusting and fixing the axial force (e.g., on a dummy structure, see FIGS. 3A and 3B). When the stator element is removed, the axial force will indeed be released in this one direction. However, the axial force will be restored by renewed fastening of the stator element.

According to an exemplary embodiment, the stator element is fixed in the valve body by the press-fit connection. In this exemplary embodiment (see, e.g., FIGS. 6A to 6C), instead of a pressing element, the stator element itself is pressed-in in order to provide the non-detachable connection. In this example, the stator element can no longer be removed in a non-destructive manner after pressing-in. A blocking element may ensure that the desired axial force can be adjusted.

According to an exemplary embodiment, a combination of pressing element and pressed-in stator element is also possible. Thus, for example, pressing-in of both, opposite sides into the valve body can take place.

According to an exemplary embodiment, the valve is free of an adjusting mechanism, in particular free of an adjusting screw. According to an exemplary embodiment, the valve is configured to be operated in a service-free manner. According to an exemplary embodiment, the adjusted axial force in the valve cannot be changed (in a non-destructive manner). As already described above, the non-detachably fixed axial force may have a plurality of advantages. In particular, a high reliability may be ensured during a long service life, wherein practically no maintenance is necessary.

According to an exemplary embodiment, the stator element or the rotor element is exchangeable. A more flexible operation may thus be made possible. According to an exemplary embodiment, the stator element and/or the rotor element comprises at least one of the following materials: metal, in particular stainless steel, ceramic, plastic. An efficient method of production with proven and established materials may thus be performed.

According to an exemplary embodiment, the method comprises: pre-mounting at least one elastic element in a valve body, and pressing a pressing element into the valve body in order to adjust the axial force by the elastic element and to fix the adjusted axial force while providing the non-detachable connection. According to an exemplary embodiment, the axial force is measured or monitored during the pressing. This may have the advantage that an efficient automation may be performed: adjusting the axial force and pressing-in may be carried out simultaneously and as soon as the desired force is reached, the pressing process may be stopped.

According to an exemplary embodiment, the method comprises: pre-mounting at least one elastic element in a valve body, blocking an expansion of the elastic element (e.g., by a blocking element) in one direction (in particular rotor side of the valve body), and pressing the stator element into the valve body in order to adjust the axial force by the elastic element against the blocking element and to fix the adjusted axial force while providing the non-detachable connection. This may have the advantage that an efficient automation may be performed: adjusting the axial force and pressing-in may be carried out simultaneously and as soon as the desired force is reached, the pressing process may be stopped.

According to an exemplary embodiment, the method comprises: applying a dummy structure (mounting element), in particular configured to measure the axial force, during the adjusting of the axial force, in the position of the rotor element and/or the position of the stator element. Such a dummy structure may comprise a measuring device or be coupled to a measuring device. This may have the advantage that an efficient automation may be performed: adjusting the axial force and pressing-in may be carried out simultaneously and as soon as the desired force is reached, the pressing process may be stopped.

According to an exemplary embodiment, the analysis device is configured as a sample separation device. According to an exemplary embodiment, the analysis device comprises a fluid drive for driving a mobile phase and a fluidic sample injected into the mobile phase. According to an exemplary embodiment, the analysis device comprises a sample separation unit for separating the fluidic sample injected into the mobile phase. According to an exemplary embodiment, the analysis device is configured for analyzing at least one physical, chemical and/or biological parameter of the fluidic sample. According to an exemplary embodiment, the analysis device is configured as a sample separation device for separating the fluidic sample.

In the context of the present application, the term “sample separation unit” may denote in particular a unit for analyzing a fluidic sample, in particular into different fractions. For this purpose, constituents of the fluidic sample may first be adsorbed on the sample separation unit and then desorbed separately (in particular fractionally). For example, such a sample separation unit may be configured as a chromatographic separation column.

According to an exemplary embodiment, the analysis device is a chromatography device, in particular a liquid chromatography device, a gas chromatography device, an SFC (supercritical fluid chromatography) device or an HPLC (high-performance liquid chromatography) device.

According to an exemplary embodiment, the analysis device is configured as a microfluidic device. According to an exemplary embodiment, the analysis device is configured as a nanofluidic device.

According to an exemplary embodiment, the sample separation unit is configured as a chromatographic separation unit, in particular as a chromatographic separation column.

According to an exemplary embodiment, the fluid drive is configured for driving the mobile phase and the fluidic sample under high pressure.

According to an exemplary embodiment, the fluid drive is configured for driving the mobile phase and the fluidic sample at a pressure of at least 500 bar, in particular of at least 1000 bar, further in particular of at least 1200 bar, or further in particular of at least 1500 bar.

According to an exemplary embodiment, the analysis device comprises a detector for detecting the analyzed, in particular separated, fluidic sample.

According to an exemplary embodiment, the analysis device comprises a fractionator for fractionating separated fractions of the fluidic sample.

The analysis device may be a microfluidic measuring device, a life science device, a liquid chromatography device, a gas chromatography device, an HPLC (high-performance liquid chromatography) device, a UHPLC (ultra-high-performance liquid chromatography) device, or an SFC (supercritical liquid chromatography) device. However, many other applications are possible.

According to an exemplary embodiment, the sample separation unit may be configured as a chromatographic separation unit, in particular as a chromatographic separation column. In a chromatographic separation, the chromatographic separation column may be provided with an adsorption medium. The fluidic sample may be stopped at this and only subsequently able to be fractionally detached again in the presence of a specific solvent composition, whereby the separation of the sample into its fractions is accomplished.

A pumping system for conveying fluid may be configured, for example, to convey the fluid or the mobile phase through the system at a high pressure, for example, a few 100 bar up to 1000 bar and more.

The analysis device may comprise a sample injector for introducing the sample into the fluidic separation path. Such a sample injector may comprise a sample or injection needle that may be coupled to a needle seat in a corresponding liquid path, wherein the sample needle may be moved out of this needle seat in order to receive sample. After the reintroduction of the sample needle into the needle seat, the sample may be located in a fluid path that may be switched into the separation path of the system, for example by switching a valve. In another exemplary embodiment of the present disclosure, a sample injector or sampler may be used with a sample needle that is operated without a needle seat.

The analysis device may comprise a fraction collector for collecting the separated components. Such a fraction collector may guide the different components of the separated sample into different liquid containers, for example. However, the analyzed sample may also be fed to a drain container.

The analysis device may comprise a detector for detecting the separated components. Such a detector may generate a signal that may be observed and/or recorded and that is indicative of the presence and quantity of the sample components in the fluid flowing through the system.

In an exemplary embodiment, a precise valve force setting with pressing sleeve for exact definition of the spring force is described. For the mounting process, the entire valve without press-in sleeve and stator is placed on a mounting tool (dummy structure). Now, with a mounting press, the desired spring force is applied to the axial bearing and the position is noted. The next step consists in pressing the sleeve in the valve body into the stored position. Finally, rotor and stator have to be installed in the valve body/mounted on the valve body/installed in the valve body.

In an exemplary embodiment, the measuring of the axial force (on the rotor) during pressing-in of the stator is described in order to set a specific axial force. However, this is also possible without measuring the actual axial force, e.g. by using known values.

### BRIEF DESCRIPTION OF THE DRAWINGS

Other aims and many of the attendant advantages of embodiments of the present disclosure will become readily apparent and will be better understood by reference to the following more detailed description of embodiments in conjunction with the accompanying drawings. Features that are substantially or functionally the same or similar are provided with the same reference signs.

FIG. 1 shows an analysis device comprising a valve, according to an exemplary embodiment of the present disclosure.

FIG. 2 shows an external view of a valve, according to an exemplary embodiment of the present disclosure.

FIG. 3A is a cross-sectional view of a part of a valve, showing adjusting an axial force in a valve by pressing-in a pressing element, according to an exemplary embodiment of the present disclosure.

FIG. 3B is a cross-sectional view of the valve illustrated in in FIG. 3A, showing adjusting an axial force in a valve by pressing-in a pressing element, according to an exemplary embodiment of the present disclosure.

FIG. 4 shows a cross-section of a valve, according to an exemplary embodiment of the present disclosure.

FIG. 5 shows a cross-section of a valve, according to an exemplary embodiment of the present disclosure.

FIG. 6A is a cross-sectional view of a valve, showing adjusting an axial force in a valve by pressing-in the stator element, according to an exemplary embodiment of the present disclosure.

FIG. 6B is a cross-sectional view of a valve, showing adjusting an axial force in a valve by pressing-in the stator element, according to an exemplary embodiment of the present disclosure.

FIG. 6C is a cross-sectional view of a valve, showing adjusting an axial force in a valve by pressing-in the stator element, according to an exemplary embodiment of the present disclosure.

The illustrations in the drawings are schematic.

### DETAILED DESCRIPTION

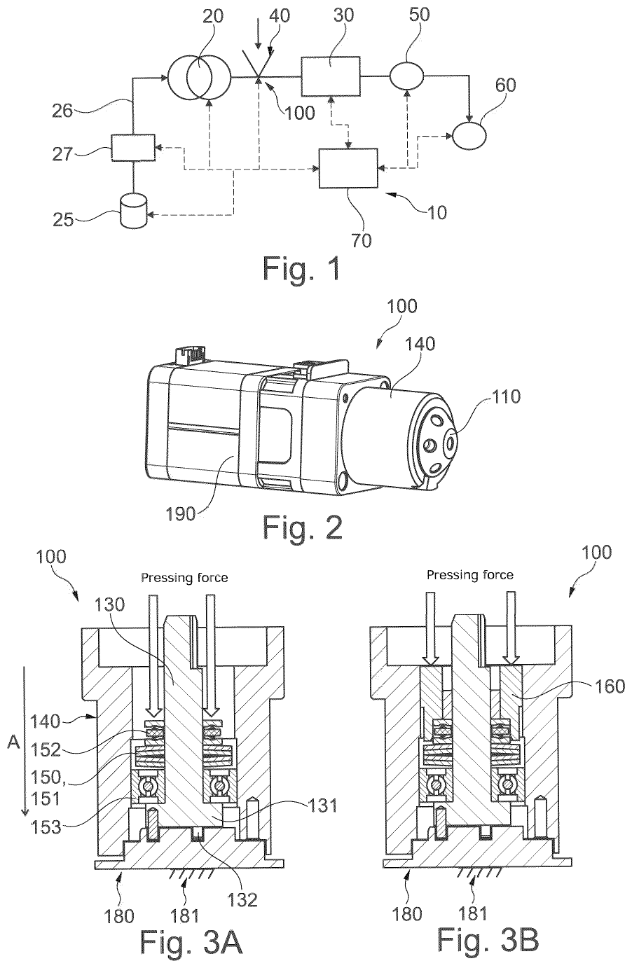

FIG. 1 shows the basic structure of an HPLC system as an example of an analysis device 10 configured as a sample separation device, according to an exemplary embodiment of the present disclosure, as it may be used for a liquid chromatography, for example. A fluid conveying device or a fluid drive 20, which is supplied with solvents from a supply unit 25, drives a mobile phase through a sample separation unit 30 (such as a chromatographic column), which contains a stationary phase. The supply unit 25 comprises a first fluid component source for providing a first fluid or a first solvent component A (for example, water) and a second fluid component source for providing another second fluid or a second solvent component B (for example, an organic solvent). An optional degasser 27 may degas the solvents provided by the first fluid component source and by the second fluid component source before they are fed to the fluid drive 20. Optionally, the solvents may be mixed at a mixing point.

A sample feed unit, which may also be denoted as an injector 40, is arranged between the fluid drive 20 and the sample separation unit 30 in order to receive a sample liquid or a fluidic sample from a sample container first into a sample receiving volume in an injector path, and subsequently to introduce it into a fluidic separation path between the fluid drive 20 and the sample separation unit 30 by switching an injection valve of the injector 40. The receiving of fluidic sample from the sample container may take place in particular in that a sample needle is moved out of a sample seat and moved into the sample container, fluidic sample is sucked out of the sample container through the sample needle into the sample receiving volume by a fluid conveying device configured as a metering unit, and the sample needle is then moved back into the needle seat.

The stationary phase of the sample separation unit 30 is provided for separating components of the sample. A detector 50, which may comprise a flow cell, detects separated components of the sample. A fractionizing device or fractionator 60 may be provided for outputting separated components of the sample into containers provided therefor. Liquids no longer required may be output into a drain container or into a waste line.

While a liquid path between the fluid drive 20 and the sample separation unit 30 is typically under high pressure, the sample liquid is first introduced under normal pressure into a region separated from the liquid path, namely the sample loop or the sample receiving volume, of the sample feed unit or of the injector 40. Thereafter, the sample liquid is introduced into the separation path that is under high pressure. A sample loop as sample receiving volume may denote a portion of a fluid line that is configured for receiving or temporarily storing a predefined quantity of fluidic sample. Even before the sample liquid that is initially under normal pressure in the sample receiving volume is switched into the separation path that is under high pressure, the content of the sample receiving volume may be brought to the system pressure of the analysis device 10 configured as an HPLC by a pressurizing device, for example a metering unit or a pump, in the form of the fluid conveying device. A control unit 70 controls the individual components 20, 25, 30, 40, 50, 60, etc., of the analysis device 10.

FIG. 1 also shows a valve 100 (see detailed description below), by which fluids, for example different solvents, fluidic samples, salt solutions or dispersions, may be mixed with one another. The valve 100 may be arranged, for example, upstream (mixing of the solvents) and/or downstream of the fluid drive 20 (mixing of solvent and fluidic sample).

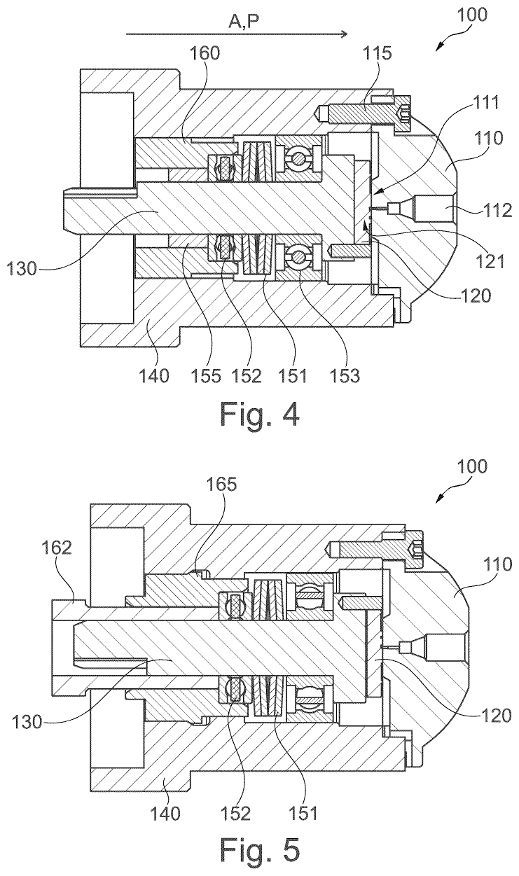

FIG. 2 shows an external view of a valve 100, according to an exemplary embodiment of the present disclosure. A block-shaped part of the housing can be seen, in which the drive device 190, for example an electric motor, is arranged. The latter drives a rotor shaft 130 (FIG. 3A) that runs through the valve body 140 and rotates the rotor element 120 (FIGS. 4 and 5) (in the housing or in the valve body 140, and which cannot be seen in FIG. 2). On the right-hand side, the valve 100 comprises a cylindrical part of the housing, in which the rotor element 120 is arranged. A part of the stator element 110 can be seen on the right-hand extremity, namely the exposed interface side to which fluid lines, for example capillaries, may be connected.

FIGS. 3A and 3B show adjusting an axial force P (axial pressing force that presses the stator element 110 and rotor element 120 together) in a valve 100, according to an exemplary embodiment of the present disclosure. In both figures, the valve body 140 (see FIG. 2 above) of the valve 100 is shown, through which the rotor shaft 130 runs. The rotor shaft 130 is coupled via a common rotor device 131 to the rotor element 120 via drive pins (rotor pins) 132, such that a rotation of the rotor shaft 130 by the drive device 190 enables a rotation of the rotor device 131 and of the rotor element 120 coupled thereto. The rotor shaft 130 is arranged along the axial direction A of the valve 100 or defines the latter.

The valve 100 comprises an elastic element 150 that is arranged along the axial direction A and may provide the axial force P or enables the adjustment thereof. In the example shown, the elastic element 150 is configured as cylindrical plate springs 151. The elastic element 150 is arranged cylindrically around the rotor shaft 130. In addition, an axial bearing 152 and a radial bearing 153 (e.g., a ball bearing or a plain bearing) are also provided in the valve body 140. In the shown example, the elastic element 151 (plate spring) is arranged between the radial bearing 153 (the latter adjoins the rotor device 131) and the axial bearing 152. All of these elements are arranged cylindrically around the rotor shaft 130.

The force with which the rotor shaft 130 will act on the rotor element 120 in the axial direction A is denoted as the axial force P. In order to set the axial force P to a desired value, a measuring device 181 is used. In the shown example, instead of the stator element 110 and the rotor element 120, a dummy structure 180 (or mounting structure) is provided that closes the opening of the valve body 140 (which would otherwise be done by the stator element 110). In contrast to the stator element 110, however, the dummy structure 180 is coupled to the measuring device 181 so that the axial force P may be measured which presses the rotor device 131 in the axial direction (no rotor element 120 has yet been inserted) against the dummy structure 180 (otherwise against the stator element 110). A part of the exerted pressing force passes via a cylindrical press-fit directly from the pressing element 160 into the valve body 140. The remaining part of the pressing force corresponds to the axial force P.

FIG. 3A: by a not shown pressing device (e.g., a mounting/servo press), a pressing force is exerted in the axial direction A on the elastic element 150. In this example, the plate springs 151 arranged between the axial bearing 152 and the radial bearing 153 are pressed together. By the pressing force, the rotor device 131 is pressed via the elastic element 150 against the dummy structure 180. By the measuring device 181, this pressure or the axial force P may be measured and monitored. When a desired axial force P (at the dummy structure 180) is applied, the pressing device may be stopped. In addition, the position of the pressing device is stored at the desired pressing force.

FIG. 3B: the desired axial force P has already been set in FIG. 3A by the elastic element 150 having been pretensioned in a specific manner. In other words, the plate springs 151 have been pressed together and pretensioned to a specific, desired value. In FIG. 3B, this pretension (or adjusted axial force) is now fixed by a pressing element 160. In the example shown, the pressing element 160 is configured in the form of a sleeve that is inserted cylindrically around the rotor shaft 130 in the axial direction A into the valve body 140. In particular, the pressing element 160 is pressed into the valve body 140 (here directly onto the axial bearing 152) in such a manner that a non-detachable press-fit connection (or cylindrical press-fit) is provided.

In other words, after pressing-in, the pressing element 160 is seated fixedly in the valve body 140 in such a manner that it cannot be removed without destroying parts of the valve 100 (or carrying out a pressing-out). Thus, the adjusted axial force P (pressing force in the axial direction), realized in this example as pretension of the plate springs 151, can no longer change. Thus, a constant pressure of the rotor device 131 against the dummy structure 180 has been adjusted.

Finally, however, the adjusted axial force P is intended to act on the rotor element 120 and the stator element 110, therefore, in the next step, the dummy structure 180 is removed and replaced by the stator element 110 (see FIG. 4).

In an exemplary embodiment, the procedure according to FIG. 3A may also be omitted and the procedure according to FIG. 3B may be started directly: pressing-in of the pressing element 160 and adjusting of the axial force P are performed simultaneously. In this case, the process is for example as follows: with the aid of the pressing force, the pressing element 160 is slowly pressed into the valve body 140. At the same time, the force is measured at the measuring device 181. As soon as the desired axial force P measured there is reached, the pressing process is stopped. The valve 100 is now fully adjusted. The dummy structure 180 is then removed and instead the rotor element 120 and stator element 110 are attached, as a result of which the plate springs 151 temporarily relax, but then the same axial force P is adjusted again.

FIG. 4 shows a cross-section of a valve 100, according to an exemplary embodiment of the present disclosure. When the dummy structure 180 of FIG. 3B is removed, the axial force P will initially decrease, or the plate springs 151 will expand again. However, as soon as the rotor element 120 is inserted and the stator element 110 is fixed in the place of the position of the dummy structure 180, the plate springs 151 are pretensioned again as previously adjusted and the axial force P is present again as previously adjusted. This state is illustrated in FIG. 4. In this exemplary embodiment, the stator element 110 is (detachably) fixed to the valve body 140 by a fastening element 115 (here a screw). Correspondingly, the axial force P is fixed in one direction of action by the non-detachable connection (press-fit) and is fixed in the opposite direction of action by the detachable connection (removable stator element 110).

The rotor boundary surface 121 of the rotor element 120 and the stator boundary surface 111 of the stator element 110 are now pressed against each other by the axial force P adjusted to the desired value (realized by the pretension of the plate springs 151).

FIG. 5 shows a further example of a valve 100, according to an exemplary embodiment of the present disclosure. In this embodiment, the complete valve 100 may be pre-mounted without spring force. The last step consists in using a pretensioning element 162 that applies the desired spring force to the axial bearing 152 by a pressing device. Thereafter, an adjusting screw 165 is attached with a defined torque. This method always ensures the same exact spring force and is simple to produce.

The adjusting screw 165 may be precisely centered by this production method. This may serve for a better guidance of the rotor shaft 130 and the rotor seal. The production process may be simple: in this way, the plate springs 151 may be pretensioned to the desired force, while the stator element 110 remains mounted.

In other words, the pretension is provided—during production—by applying a specific pretensioning element 162 for compressing the spring 151 to a desired force. Subsequently, an adjusting screw 165 is screwed-in in order to secure and hold/take over the force exerted by the pretensioning element 162, so that the pretensioning element 162 may then be removed.

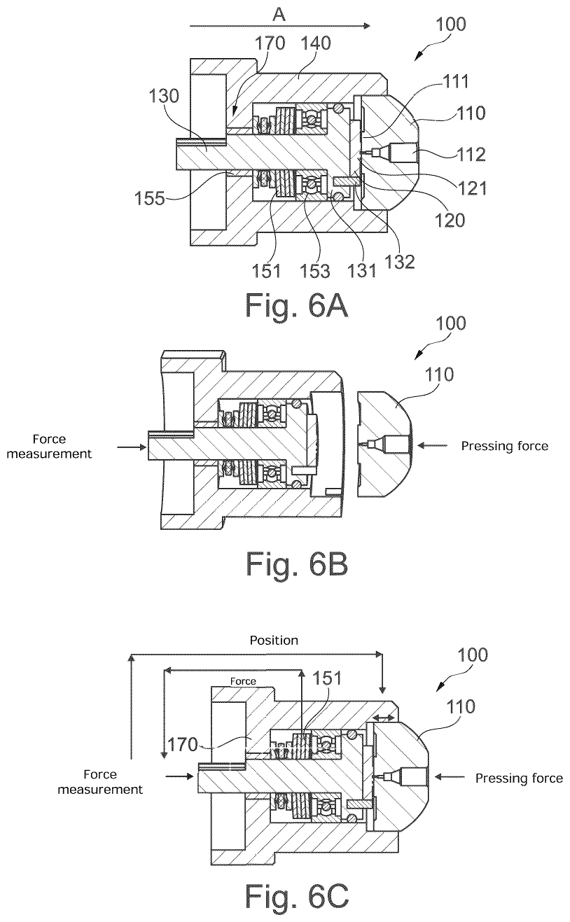

FIGS. 6A to 6C show adjusting an axial force P in a valve 100 when inserting the stator element 110, according to an exemplary embodiment of the present disclosure. In FIGS. 3A, 3B and 4, a first production method has been described in which a pressing force acts on a stator dummy 180 from the rotor side in order to adjust the desired axial force. In FIGS. 6A to 6C, a further production method is described in which a blocking element 170 is provided on the rotor side and the pressing force is provided on the stator side. In other words, instead of a rotor-side pressing element, the stator element 110 is pressed into the valve body 140 on the stator side.

FIG. 6A: a valve body 100 is provided that is similar to that of FIG. 4, wherein the rotor element 120 and the stator element 110 are already inserted. However, the difference consists primarily in that a blocking element 170 is provided cylindrically around the rotor shaft 130. Here, the blocking element 170 is part of the valve body 140 and terminates behind the axial bearing 152. In other words, the blocking element 170 prevents the elastic element 150 from being pushed further into the valve body 140 under the action of a stator-side pressing force. Instead, a stator-side axial force will ensure that the elastic element 150 is pretensioned, since there is no possibility of evasion for the elastic element 150 due to the blocking element 170.

FIG. 6B: a measuring device (not shown) is provided on the rotor side (the force measurement is illustrated schematically), so that a force acting axially on the stator side may be measured and observed. The stator element 110 was initially separated from the rotor element 120 and is now pressed into the valve body 140 by an axial (stator-side) pressing force.

FIG. 6C: the stator element 110 is pressed into the valve body 140 and against the rotor element 120 by this pressing force. The plate spring 151 (elastic element 150) is pressed together, since the blocking element 170 prevents the spring from spreading. By the measuring device (see force measurement), it may be determined which force acts on the elastic element 150. At the same time, this force measurement may be compared/correlated with the position of the inserted stator element 110. When the desired axial force (realized as adjusting the pretension of the plate springs 151) is reached, the pressing force on the stator element 110 may be stopped. At this time, the stator element 110 is already pressed into the valve body 140 in such a manner that a non-destructive release is impossible. Instead, the stator element 110 was fixed in the valve body 140 by a press-fit connection. Correspondingly, the axial force P is also fixed, which presses the rotor boundary surface 121 and the stator boundary surface 111 together as adjusted. In this exemplary embodiment, the axial force P is fixed in both opposite directions of action by a non-detachable connection.

In a further exemplary embodiment, the procedure may be as follows: the force measurement will always measure the pressing force (and not the plate spring force). The first pressing takes place without the stator element 110 in order to find the position at which the desired axial force P is reached. The stator element 110 is then pressed into this position.

In a further exemplary embodiment, the procedure may be as follows: iteratively, press-in the stator element 110 again and again a little, then pull at the rotor shaft 130 until it moves. The force at which the rotor shaft 130 begins to move corresponds to the axial force P.

### REFERENCE SIGNS

10 Analysis device
20 Fluid drive
25 Supply unit
27 Degasser
30 Sample separation unit
40 Injector
50 Detector
60 Fractionator
70 Control unit
100 Valve
110 Stator element
111 Stator boundary surface
112 Fluid port
115 Fastening element, screw
120 Rotor element
121 Rotor boundary surface
130 Rotor shaft
131 Rotor device
132 Rotor pin
140 Valve body
150 Elastic element
151 Plate spring
152 Axial bearing
153 Radial bearing
155 Guide element
160 Pressing element
162 Pretensioning element
165 Adjusting screw
170 Blocking element
180 Dummy structure
181 Measuring device
190 Drive device
A Axial direction
P Axial force

1. A valve for an analysis device for analyzing a fluidic sample, the valve comprising:
a stator element comprising a stator boundary surface; and
a rotor element comprising a rotor boundary surface, wherein:
the stator element and the rotor element are arranged in an axial direction;
the stator boundary surface and the rotor boundary surface are pressed against each other in the axial direction by an axial force; and
the axial force is fixed by a non-detachable connection in at least one direction of action.

2. The valve according to claim 1, wherein the non-detachable connection comprises at least one features selected from the group consisting of: a form-fit connection; a press-fit connection; a material connection; an adhesive connection; a soldered connection' a welded connection; a connection free of detachable connection elements; and a connection free of screws.

3. The valve according to claim 1, comprising at least one of the following features:
the axial force comprises a spring force;
the axial force is fixed to a predetermined value.

4. The valve according to claim 1, comprising at least one of the following features:
wherein the valve is configured as a rotary valve;
wherein the valve is configured as a high-pressure valve;
wherein the valve is configured as a fluid switching valve;
wherein valve is configured to be closed by the axial force in a fluid-tight manner.

5. The valve according to claim 1, comprising a rotor shaft coupled to the rotor element, wherein the rotor shaft is configured to enable a rotation of the rotor element, and the rotor shaft is arranged along the axial direction.

6. The valve according to claim 1, comprising at least one elastic element arranged in the axial direction and configured to provide at least a part of the axial force.
a blocking element arranged in the axial direction and configured to block an expansion of the elastic element in a direction of action, and an axial bearing arranged between the blocking element and the elastic element;
a radial bearing;
a radial bearing arranged between the elastic element and the rotor element.

11. The valve according to claim 1, comprising a valve body in which the rotor element and at least a part of the stator element are arranged.

12. The valve according to claim 1, comprising at least one of the following features:
wherein the stator element is fastened to the valve body;
wherein the stator element is fastened to the valve body by a detachable connection;
wherein the stator element is fastened to the valve body by a screw connection.

13. The valve according to claim 1, wherein the stator element is fixed in the valve body by the press-fit connection.

14. The valve according to claim 1, comprising at least one of the following features:
wherein the valve is free of an adjusting mechanism;
wherein the valve is configured to be operated in a service-free manner;
wherein the adjusted axial force in the valve cannot be changed;
wherein the stator element is exchangeable;
wherein the stator element comprises a material selected from the group consisting of: metal; stainless steel; ceramic; and plastic;
wherein the rotor element comprises a material selected from the group consisting of: metal; stainless steel; ceramic; and plastic.

15. An analysis device for analyzing a fluidic sample, the analysis device comprising:
the valve according to claim 1; and
an analytical system.

7. The valve according to claim 6, wherein the elastic element comprises at least one feature selected from the group consisting of the elastic element is configured as a spring; the elastic element is configured as a plate spring; the elastic element is cylindrical; and the elastic element is arranged around the rotor shaft.

8. The valve according to claim 1, comprising at least one of the following features:
a pressing element fixed in the axial direction by the press-fit connection;
a pressing element fixed in the axial direction by the press-fit connection, wherein the pressing element is cylindrical;
a pressing element fixed in the axial direction by the press-fit connection, wherein the pressing element is arranged around the rotor shaft;
a pressing element fixed in the axial direction by the press-fit connection, wherein the elastic element is arranged between the pressing element and the rotor element.

9. The valve according to claim 1, comprising at least one of the following features:
a blocking element arranged in the axial direction and configured to block an expansion of the elastic element in a direction of action;
a blocking element arranged in the axial direction and configured to block an expansion of the elastic element in a direction of action, wherein the blocking element is configured as part of the valve body;
a blocking element arranged in the axial direction and configured to block an expansion of the elastic element in a direction of action, wherein the blocking element is arranged around the rotor shaft;
a blocking element arranged in the axial direction and configured to block an expansion of the elastic element in a direction of action, wherein the elastic element is arranged between the blocking element and the rotor element.

10. The valve according to claim 1, comprising at least one of the following features:
an axial bearing;
a pressing element fixed in the axial direction by the press-fit connection, and an axial bearing arranged between the pressing element and the elastic element;

16. The analysis device according to claim 15, comprising at least one of the following features:
the analysis device is configured as a sample separation device;
the analysis device comprises a fluid drive configured to drive a mobile phase and a fluidic sample injected into the mobile phase;
the analysis device comprises a fluid drive configured to drive a mobile phase and a fluidic sample injected into the mobile phase at a pressure of at least 500 bar;
the analysis device comprises a fluid drive configured to drive a mobile phase and a fluidic sample injected into the mobile phase at a pressure of at least 1000 bar;
the analysis device comprises a fluid drive configured to drive a mobile phase and a fluidic sample injected into the mobile phase at a pressure of at least 1200 bar;
the analysis device comprises a fluid drive configured to drive a mobile phase and a fluidic sample injected into the mobile phase
the analysis device comprises a sample separation unit configured to separate the fluidic sample injected into the mobile phase;
the analysis device is configured for analyzing at least one of a physical parameter of the fluidic sample, a chemical parameter of the fluidic sample, or a biological parameter of the fluidic sample;
the analysis device is configured as a sample separation device configured to separate the fluidic sample;
the analysis device is configured as a chromatography device;
the analysis device is configured as a microfluidic device;
the analysis device is configured as a nanofluidic device;
the sample separation unit is configured as a chromatographic separation unit;
the analysis device comprises a detector configured to detect the analyzed or separated fluidic sample;
the analysis device comprises a fractionator configured to fractionate separated fractions of the fluidic sample.

17. A method for manufacturing a valve, the method comprising:
pressing a stator element and a rotor element against each other in an axial direction with an axial force;
adjusting the axial force; and
fixing the axial force (P) by a non-detachable connection in at least one direction of action.

18. The method according to claim 17, comprising:
pre-mounting at least one elastic element in a valve body;
pressing a pressing element into the valve body to adjust the axial force by the elastic element and to fix the adjusted axial force while providing the non-detachable connection; and
measuring the axial force during the pressing.

19. The method according to claim 17, comprising:
pre-mounting at least one elastic element in a valve body;
blocking an expansion of the elastic element by a blocking element in one direction;
pressing the stator element into the valve body to adjust the axial force by the elastic element against the blocking element and to fix the adjusted axial force while providing the non-detachable connection; and
measuring the axial force during the pressing.

20. The method according to claim 17, comprising:
applying a dummy structure, configured to measure the axial force, during the adjusting of the axial force, in the position of the rotor element and/or the position of the stator element.
